(19) United States
(12) Patent Application Publication
(10) Pub. No.: US 2009/0288899 A1
(43) Pub. Date: Nov. 26, 2009

(54) Vehicle with multiple engines coupled to a transmission via a jackshaft

(76) Inventor: Gregorio M. Belloso, Salisbury, MD (US)

Correspondence Address: Norman B. Rainer, 2008 Fondulac Road, Richmond, VA, 23229, US

(21) Appl. No.: 12/152,943

(22) Filed: May 20, 2008

(51) Int. Cl. B60K 5/08

(52) U.S. Cl. 180/69.6

(57) ABSTRACT

A motor vehicle is provided with a power train having primary and auxiliary internal combustion engines which selectively feed power to a jackshaft. The power accumulated in the jackshaft is conveyed to a speed change transmission. Fuel economy is achieved by utilizing only one engine when lesser power is needed by the vehicle.

### BACKGROUND OF THE INVENTION

1. Field of the Invention

This invention relates to a vehicle having multiple internal combustion engines whose power output can be combined and routed to a transmission for the purpose of improving fuel efficiency and accommodating the power needs of the vehicle.

2. Description of the Prior Art

Increasing greenhouse gas emissions to the atmosphere and the increasing cost of fossil fuels have driven the search for means to improve automotive fuel efficiency. One solution has been the hybrid automobile which uses a small fuel-efficient internal combustion engine augmented by a battery-driven electric motor to power the vehicle. Another solution uses two or more internal combustion engines, using their combined power for acceleration, climbing steep grades, etc., and using the power of one engine to cruise economically.

The present invention relates to the latter solution, using multiple engines for acceleration, and using one engine to cruise.

Prior vehicles using multiple engines have problems related to the need to design and fabricate new transmission components and even to design entirely new engine blocks and parts thereof to result in a useful product. These requirements entail substantial expenditure of time, technical expertise and financial resources for the design, fabrication, testing and manufacturing of essentially new and untested technology which will then need to be perfected and made reliable to be profitably marketable.

U.S. Pat. No. 7,270,030 to Belloso describes a speed changing transmission with multiple input ports for multiple-engine vehicles. It calls for a substantial redesign of the transmission, using new parts therefor, so that multiple engines can be bolted onto it. It is not amenable to the use of an unmodified speed change gearbox.

U.S. Pat. No. 6,637,283 to Belloso describes a control apparatus for a continuously variable transmission capable of receiving power from a plurality of engines. It requires a totally new design of a speed change gearbox which would entail substantial design and development costs and then extensive reliability testing before it can be marketable.

U.S. Pat. No. 7,080,622 to Belloso describes an internal combustion engine with multiple independently rotating crankshafts and a common output shaft, which functions like a combination of engines in one vehicle. It calls for the design of an entirely new type of engine block and the installation of novel components therein. This would call for substantial design, tooling, fabrication and testing costs before it can be ready for mass manufacture.

It is, therefore, an object of this invention to provide a vehicle equipped with two or more engines for the purpose of achieving improved fuel efficiency through the use of currently available manual or automatic speed change transmissions without the need to make substantial modifications thereof.

It is another object of the present invention to provide a vehicle of the aforesaid nature wherein the operational speed of each engine is separately controllable, and the output powers of said engines can be accumulated and fed to a speed change transmission.

These objects and other objects and advantages of the invention will be apparent from the following description.

### SUMMARY OF THE INVENTION

The above and other beneficial objects and advantages are accomplished in accordance with the present invention by a motor vehicle having a chassis elongated upon a center axis between paired front and paired rear wheels, and a power train comprised of:
a) primary and auxiliary internal combustion engines located one in front of the other adjacent said front wheels, each engine having a power output shaft extending in parallel juxtaposition with said center axis and both having the same direction of rotary motion,
b) releasible coupling and power transfer means associated with each output shaft,
c) a speed change transmission positioned rearwardly of said engines and having an input shaft, and
d) a jackshaft laterally spaced from said engines in parallel relationship to said center axis, and rotatably secured by said chassis to selectively receive and accumulate power from said engine output shafts and convey said accumulated power to the input shaft of said speed change transmission, whereby
e) economy of operation is achieved by deactivating one engine when lesser power is needed for propulsion of the vehicle.

Said releasable coupling and power transfer means may be a movable sheave torque converter unit (CVT) that produces continuously variable output rotational speeds, or may be a fluid torque converter. Still other specific embodiments of the releasible coupling and power transfer means include releasible automatic or manually activated clutches such as a centrifugal clutch, electromagnetic power clutch, cone clutch and friction plate clutch.

Said jackshaft may be divided into sections, each section being interactive with a separate engine, with each section releasibly coupled to the next contiguous section by way of a suitable coupling means such as a free wheeling clutch such as a sprag clutch. Such construction serves to ensure more complete decoupling of one engine from the other during low power operations such as when traveling at cruising speeds on a highway.

The primary engine may be made to have about ½ to ⅓ the size and power capacity of the auxiliary engine to maximize fuel economy while cruising with minimum load, and to maximize performance in acceleration and other heavy duty capacity. Furthermore, each engine may be coupled to the jackshaft via a free-wheeling clutch, such as a sprag clutch, so that it becomes possible to choose to power the vehicle with only the primary engine for light duty operation (e.g., for cruising with minimum load), or with only the auxiliary engine for medium duty operation (e.g., for cruising when fully loaded), and with power from both the primary engine and the auxiliary engine for maximal acceleration or heavy duty operation.

In general, an internal combustion engine is most fuel-efficient when it is operated at about 60% to 90% of its rated capacity. It is generally less fuel-efficient when operated outside this range. Furthermore, an automobile weighing about 3000 lbs may need only about 30 horsepower (HP) to maintain cruising speed on the highway, but may need about 120 HP to accelerate within an acceptably short time to keep up with traffic. In a conventional automobile equipped with only one engine, this vehicle would have to be equipped with an engine having a rated capacity of at least 120 HP, yet when it is operated to produce only 30 HP for cruising it would be operating at only 25% of its rated capacity which is too far below the 60% to 90% range of its rated capacity for it to be fuel-efficient. It would be preferable, from the fuel efficiency standpoint, for the vehicle to be powered by a 40 HP engine for cruising, since this engine would then be operating at 75% of its rated capacity, i.e. at the middle of its most fuel efficient range.

To permit selective use of either the primary engine or the auxiliary engine, or both, the fuel supply of each engine may be controlled through a separate gas pedal for each engine. Said gas pedals may be most conveniently operated by the operator's right foot if they are placed next to each other in the usual location of the gas pedal, with their size and position being adjusted so that either pedal may be independently depressed to control the operation of either engine, or both may be depressed together, by the right foot, to operate both engines at the same time.

Alternatively, load sensors associated with the power train may be used to send input data to a vehicle's power management computer to regulate selective use of either or both engines, as needed, to suit operating conditions.

### BRIEF DESCRIPTION OF THE DRAWING

For a fuller understanding of the nature and objects of the invention, reference should be had to the following detailed description taken in connection with the accompanying drawing forming a part of this specification and in which similar numerals of reference indicate corresponding parts in all the figures of the drawing:

FIG. 1 is a schematic top view of an embodiment of the vehicle of the present invention.

FIG. 2 is a schematic top view of a first alternative embodiment of the vehicle of the present invention.

FIG. 3 is a schematic top view of a second alternative embodiment of the vehicle of the present invention.

FIG. 4 is a schematic top view of a third alternative embodiment of the vehicle of the present invention.

FIG. 5 is a schematic top view of a fourth alternative embodiment of the vehicle of the present invention.

FIG. 6 is a schematic top view of a fifth alternative embodiment of the vehicle of the present invention.

For clarity of illustration, details which are not relevant to the invention, such as engine mounts, transmission mounts, undercarriage of the vehicle, and internal parts of the transmission and differential, etc., have been omitted from the aforesaid drawings. Furthermore details of the internal parts of the electric motors, generators, CVT torque converters and sprag clutches, which are well known in the art and readily available in the standard texts on the subjects, are likewise omitted from the aforesaid drawings.

### DESCRIPTION OF THE PREFERRED EMBODIMENT

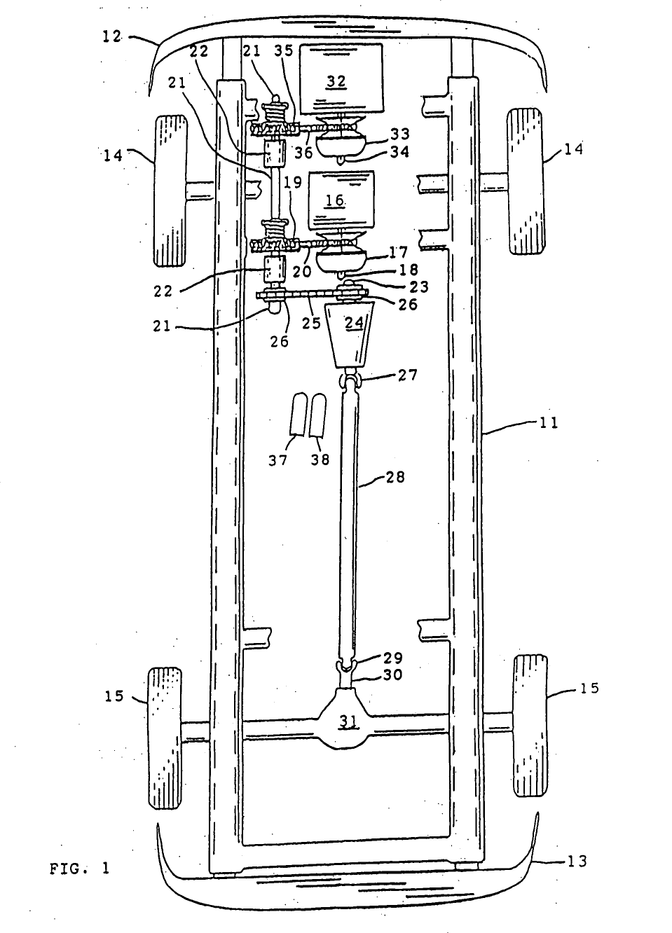

Referring now to the drawings wherein one character designates one part of the vehicle, FIG. 1 shows a vehicle of the present invention having a chassis 11 connected to front bumper 12 and rear bumper 13, and supported by paired front wheels 14 and paired rear wheels 15.

A power train is shown comprised of primary “cruiser” engine 16 mounted on chassis 11. Primary CVT driver pulley 17 is mounted on output shaft 18 of said primary engine, and is connected to primary CVT driven pulley 19 by drive belt 20. Driven pulley 19 is fixedly mounted on jackshaft 21 which is rotatably journaled on bearings 22 which are anchored on chassis 11. Jackshaft 21 is connected to input shaft 23 of speed change transmission 24 via chain 25 and sprockets 26. Power from speed change transmission 24 is conveyed via front universal joint 27, propeller shaft 28, rear universal joint 29, pinion 30, and differential 31 to the rear wheels 15 to drive the vehicle.

The size and power capacity of primary engine 16 is designed to be sufficient to keep the vehicle at cruising speed on a fairly level highway, but small enough so that it can maintain said cruising speed in the most fuel-efficient manner.

For heavy duty operation, such as for acceleration, towing, carrying heavy load, or climbing a steep grade, the vehicle is equipped with an auxiliary engine 32 whose size and power capacity is designed so that, when it is operated together with primary engine 16, their combined power will be sufficient to power the vehicle during said heavy duty operations.

Auxiliary CVT drive pulley 33 is mounted on the output shaft 34 of auxiliary engine 32 and is connected to auxiliary driven pulley 35 by auxiliary drive belt 36. Auxiliary driven pulley 35 is fixedly mounted on jackshaft 21 so that when both primary engine 16 and auxiliary engine 32 are operated at the same time, their combined power is conveyed by jackshaft 21 to speed change transmission 24 thence to said rear wheels. The two engines 16 and 32 are operated together for acceleration and other heavy duty operations. After the vehicle reaches cruising speed, auxiliary engine 32 is throttled down to idle speed or stopped to conserve fuel, and the vehicle is maintained at cruising speed by power from primary engine 16 alone.

The CVT torque converter, comprised of drive pulley 33, drive belt 36 and driven pulley 35, automatically becomes disengaged when auxiliary engine 32 runs below a minimum “engagement speed” such as when it is stopped or run at idle speed. Accordingly, when the vehicle is traveling at cruising speed, the slowed or stopped auxiliary engine 32 is automatically disengaged from the rest of the power train so that it will not exert a drag on primary engine 16. If engine 32 runs at idle speed, its power is readily available when needed by simply increasing its fuel supply. If it is stopped, means for it to be quickly restarted to provide auxiliary power may be provided, in a manner similar to current hybrid vehicles.

Primary engine gas pedal 37 regulates fuel supply to primary engine 16, and auxiliary engine gas pedal 38 regulates fuel supply to auxiliary engine 32. The driver, therefore, is able to selectively operate either engine 16 or engine 32 by selectively depressing its corresponding gas pedal, 37 or 38. To operate both engines 16 and 32 at the same time, he simply depresses both pedals simultaneously.

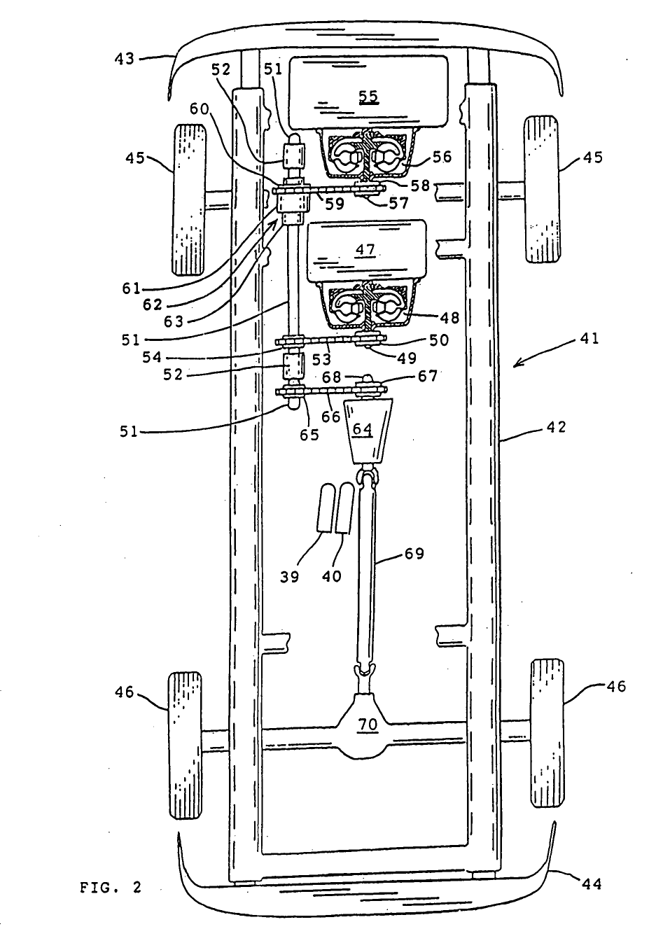

FIG. 2 shows a first alternative embodiment of the vehicle 41 having a chassis 42, front bumper 43, rear bumper 44, front wheels 45 and rear wheels 46. Primary engine 47 is coupled to a fluid torque converter 48 on whose output shaft 49 is mounted drive sprocket 50. Jackshaft 51 is mounted alongside primary engine 47 rotatably journaled on bearings 52 which are anchored on chassis 42. Power from primary engine 47 is transmitted to jackshaft 51 via torque converter 48, drive sprocket 50, endless chain 53 and driven sprocket 54 which is fixedly mounted on jackshaft 51.

The size and power capacity of primary engine 47 is selected to be sufficient to maintain the vehicle 41 at cruising speed, and yet be small enough to perform such function in the most fuel-efficient manner.

For heavy duty operation, such as acceleration and climbing a steep grade, auxiliary engine 55 is installed in vehicle 41 to provide additional power. Auxiliary engine 55 is coupled to auxiliary fluid torque converter 56 on whose output shaft 57 is mounted auxiliary drive sprocket 58 which is connected by endless chain 59 to driven sprocket 60 which is fixedly attached to the outer race 61 of sprag clutch 62 whose inner race 63 is fixedly mounted on jackshaft 51. Jackshaft 51 is connected to speed change transmission 64 via jackshaft drive sprocket 65, endless chain 66 and driven sprocket 67 which is mounted on input shaft 68 of transmission 64.

The power capacity and size of auxiliary engine 55 is selected so that its power output, when combined with the power output of primary engine 47 will be sufficient to give the vehicle 41 satisfactory performance in acceleration, climbing a grade and other heavy duty operations in which the vehicle is expected to be used.

To operate the vehicle, primary engine 47 and auxiliary engine 55 are started and speeded up. Power from primary engine 47 is conveyed via fluid torque converter 48, thence through chain 53 and sprockets 50 and 54 to jackshaft 51, thence via chain 66 and sprockets 65 and 67 to speed change transmission 64 which is shifted to “drive” thereby transmitting power to propeller shaft 69 and differential 70 to drive wheels 46. Additional power from auxiliary engine 55 is conveyed via auxiliary fluid torque converter 56 through chain 59 and sprockets 58 and 60 thence via sprag clutch 62 and jackshaft 51 to chain 66, sprockets 65 and 67 and transmission 64 to supply additional power to the wheels 46.

After the vehicle 41 reaches cruising speed, auxiliary engine 55 is throttled down to idle speed or stopped altogether to conserve fuel. When auxiliary engine 55 is slowed down or stopped, sprag clutch 62 disengages outer race 61 automatically from inner race 63 thereby decoupling the auxiliary engine 55 completely from jackshaft 51 and preventing the auxiliary engine 55 from exerting a drag force on the vehicle. Vehicle 41 then continues to travel, fuel-efficiently, on power from primary engine 47 alone.

Whenever additional power is again needed, the operator simply feeds more fuel to auxiliary engine 55, speeding it up, which will cause sprag clutch 62 to be automatically engaged, thereby transmitting the additional power to jackshaft 51 to help power the vehicle.

FIG. 2 shows auxiliary engine 55 to be substantially larger than primary engine 47. This is to illustrate that for the purpose of maximizing fuel economy it may be advantageous to downsize the cruiser engine (in this case, primary engine 47) to about one-fourth of the total power capacity available to the vehicle. The literature suggests that the average automobile is able to cruise comfortably, on a relatively level highway, using as little as about 25 to 35 horsepower which is approximately one-fourth of the power output of the engine of an average automobile. Conversely, for maximal performance, the power of the auxiliary engine may be selected to be two to four times that of the primary engine.

Primary engine gas pedal 39 regulates fuel supply to primary engine 47 and auxiliary engine gas pedal 40 regulates fuel supply to auxiliary engine 55. The operator, therefore, is able to selectively operate either engine 47 or engine 55 by selectively depressing its corresponding gas pedal, 39 or 40. To operate both engines at the same time he simply depresses both pedals simultaneously with one foot which is easy to do since the two pedals are located side by side.

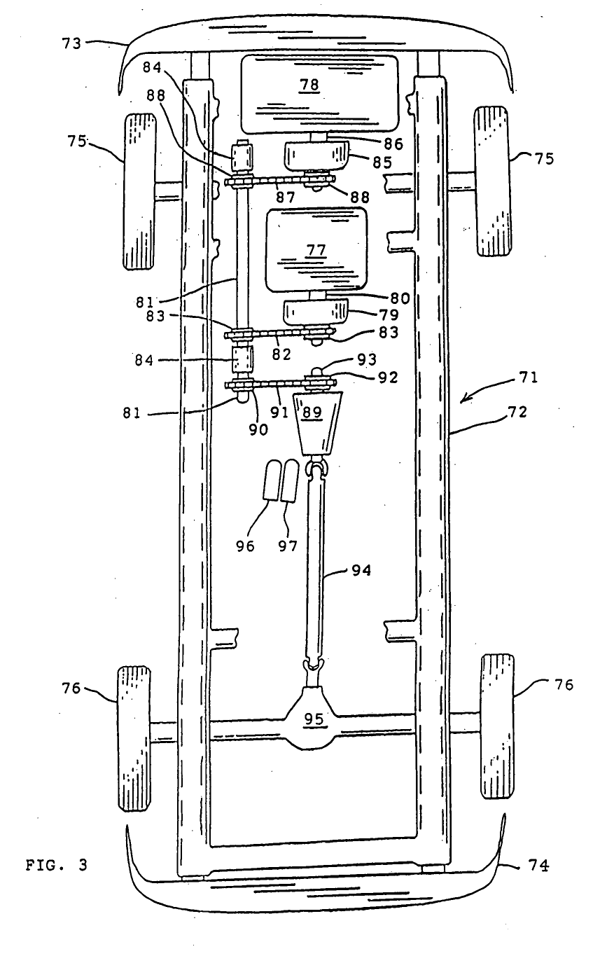

A second alternative embodiment, illustrated in FIG. 3, shows a vehicle 71 having a chassis 72, front bumper 73, rear bumper 74, front wheels 75, rear wheels 76, primary engine 77 and auxiliary engine 78. A centrifugal clutch 79 is mounted on the output shaft 80 of primary engine 77 and is coupled to jackshaft 81 by endless chain 82 and sprockets 83. Jackshaft 81 is rotatably mounted on bearings 84. Auxiliary centrifugal clutch 85 is mounted on the output shaft 86 of auxiliary engine 78, and is connected to jackshaft 81 by endless chain 87 and sprockets 88.

To operate the vehicle 71, primary engine 77 and auxiliary engine 78 are started and speeded up. Centrifugal clutch 79 has a preset “engagement speed” and when the rotational speed of output shaft 80 exceeds the engagement speed the centrifugal clutch 79 automatically engages and transmits power to jackshaft 81 via endless chain 82 and sprockets 83. Similarly, auxiliary centrifugal clutch 85 has a preset engagement speed, and when the rotational speed of output shaft 86 exceeds this engagement speed the centrifugal clutch 85 automatically engages and transmits power to jackshaft 81 via endless chain 87 and sprockets 88. Jackshaft 81 then transmits this combined power of the two engines 77 and 78 to transmission 89 via jackshaft sprocket 90, endless chain 91 and transmission sprocket 92 which is mounted on transmission input shaft 93. Power from transmission 89 is then conveyed through propeller shaft 94 and differential 95 to drive wheels 76 to propel the vehicle 71.

When vehicle 71 reaches cruising speed auxiliary engine 78 is slowed down to idle speed (or stopped altogether) to conserve fuel. When the rotational speed of output shaft 86 falls below the engagement speed of centrifugal clutch 85, centrifugal clutch 85 automatically disengages so that auxiliary engine 78 will not exert any drag on the vehicle. Vehicle 71 then continues traveling economically on power from primary engine 77 alone.

When additional power is needed such as for accelerating to pass another vehicle, or to climb a grade, auxiliary engine 78 is simply speeded up to be re-engaged automatically via centrifugal clutch 85, or, if it had been stopped, it is then restarted and speeded up to supply additional power as needed.

Although a centrifugal clutch is shown in this embodiment, other types of clutches can be used, such as an electromagnetic clutch, friction clutch, or toroidal torque converter.

Primary engine gas pedal 96 regulates fuel supply to primary engine 77, and auxiliary engine gas pedal 97 regulates fuel supply to auxiliary engine 78. The operator, therefore, may selectively operate either engine 77 or engine 78 by selectively depressing its corresponding gas pedal, 96 or 97. To operate both engines at the same time he simply depresses both pedals simultaneously.

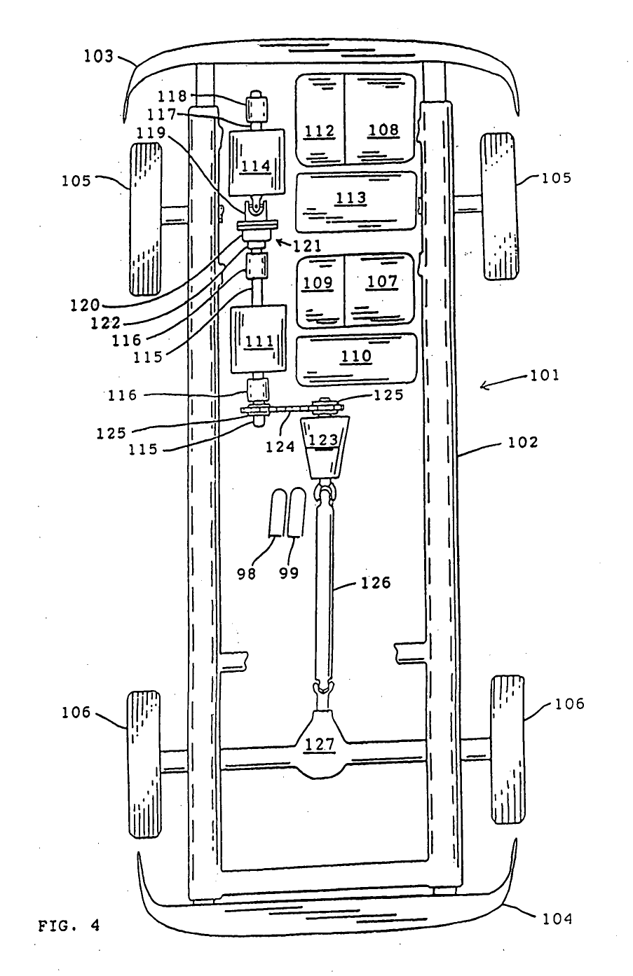

A third alternative embodiment is illustrated in FIG. 4 which shows a vehicle 101 having a chassis 102, front bumper 103, rear bumper 104, front wheels 105, rear wheels 106, primary engine 107 and auxiliary engine 108. Primary engine 107 is directly coupled to primary generator 109 which is used to charge primary battery 110 and supply electricity to primary electric motor-generator 111. Auxiliary engine 108 is directly coupled to auxiliary generator 112 which is used to charge auxiliary battery 113 and supply electricity to auxiliary electric motor 114. Primary motor-generator 111 is directly mounted on primary jackshaft 115 which is integrated into motor-generator 111 by serving as the axial shaft of the armature of said motor-generator 111. Jackshaft 115 is rotatably journaled to primary jackshaft bearings 116.

Auxiliary electric motor 114 is directly mounted on auxiliary jackshaft 117 which is integrated into electric motor 114 by serving as the axial shaft of the armature of said electric motor 114. The front end of auxiliary jackshaft 117 is rotatably journaled to auxiliary jackshaft bearing 118, and its rear end is flexibly coupled via universal joint 119 to the outer race 120 of sprag clutch 121 whose inner race 122 is mounted on a forward extension of jackshaft 115. Sprag clutch 121 is a freewheeling clutch which automatically engages, in this application, when the speed of rotation of the outer, “driver” race 119 exceeds the rate of rotation of the inner (“driven”) race 122, and then automatically disengages when the speed of rotation of outer race 120 falls below the speed of rotation of the inner race 122.

To operate the vehicle 101 primary engine 107 is started up and run to power generator 109 which supplies electricity to battery 110 and motor-generator 111. Battery 110 also supplies stored current to motor-generator 111 which then transmits mechanical power to jackshaft 115. Similarly, auxiliary engine 108 is started and speeded up to drive generator 112 which supplies electric power to battery 113 and auxiliary electric motor 114, which, upon activation, transmits mechanical power to auxiliary jackshaft 117, thence via universal joint 119, sprag clutch outer race 120 which then drives inner race 112 which conveys additional mechanical power to jackshaft 115 upon which it is mounted. The combined power of both electric motors 111 and 114 is then conveyed to speed change transmission 123 via endless chain 124 and sprockets 125, thence to propeller shaft 126 and differential 127 to drive wheels 106.

To control the operation of the vehicle a rheostat pedal may be employed in place of the gas pedal in the operator's seating area so that he can control the flow of power from electric motors 111 and 114 in accordance to the power needed for the proper operation of the vehicle. The primary engine 107 and auxiliary engine 108 may be equipped with preset controls to permit automatic starting and running of each engine to replenish the charge of each's associated battery whenever said battery is discharged to a predetermined degree, and to automatically stop running when said batteries are fully charged. Said automatic controls may be further designed to run said engines at optimal speeds to supply additional power to the associated electric motors whenever the operator signals a need for more electricity than what the batteries can deliver.

When the vehicle 101 reaches cruising speed, auxiliary electric motor 114 may be deactivated so that the vehicle can travel economically on power from motor-generator 111 alone.

The size and power capacity of primary engine 107 and associated generator 109, battery 110 and motor-generator 111 are selected so that they are sufficient to permit vehicle 101 to travel comfortably and maintain cruising speed on a relatively level highway, with maximal fuel economy, without the need to receive additional power from auxiliary electric motor 114. Fuel efficiency is further maximized by recharging battery 110 with electricity generated by motor-generator 111 through regenerative braking, a means well known in the art.

The size and power capacity of auxiliary engine 108 and associated generator 112, battery 113 and electric motor 114 are selected so that they are capable of supplying sufficient additional power, as needed, to permit said vehicle 101 to have satisfactory performance in acceleration, climbing a grade, carrying loads or towing, as demanded by the operator, to a degree reasonably expected of a regular motor vehicle.

The interposition of electrical components (generator, battery and electric motor) to transmit power from the engines (primary and auxiliary) to the jackshaft permits operation of said engines at their most fuel efficient speeds as needed, and for them to be shut down to save fuel when additional electricity is not needed.

Rheostat pedal 98 regulates the flow of current to primary motor-generator 111, and rheostat pedal 99 regulates the flow of current to auxiliary electric motor 114. The operator, therefore, is able to selectively operate either primary motor-generator 111 or auxiliary electric motor 114 by selectively depressing corresponding rheostat pedals 98 or 99. To operate both motors at the same time he simply depresses both rheostat pedals simultaneously.

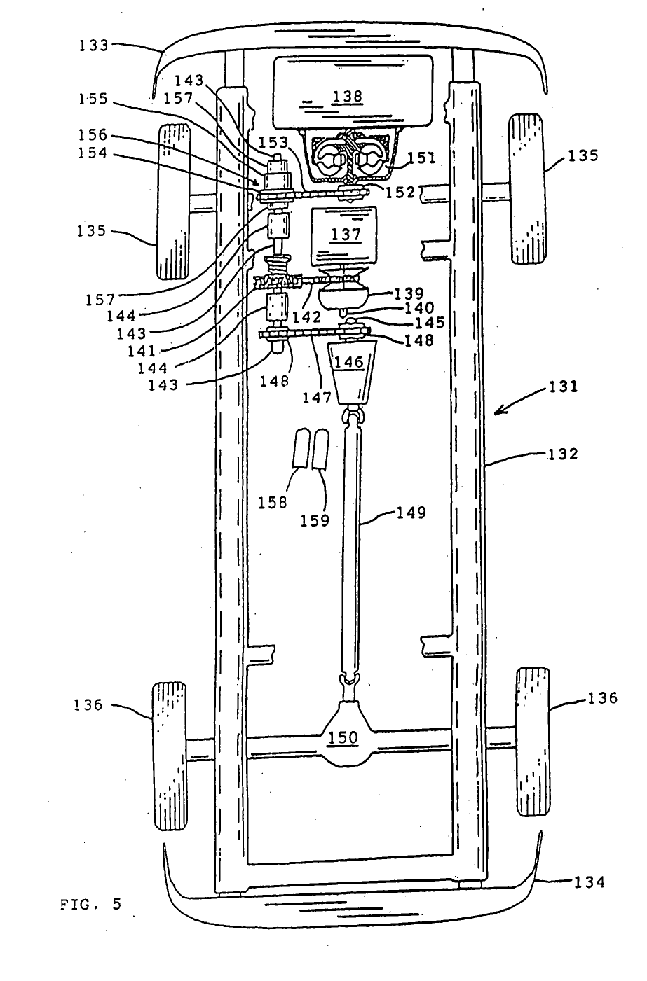

FIG. 5 shows how additional alternative embodiments may be made by combining certain features of any of the foregoing embodiments with selected features of another. The fourth alternative embodiment shown in FIG. 5 comprises a vehicle 131 having a chassis 132, front bumper 133, rear bumper 134, front wheels 135, rear wheels 136, primary engine 137 and auxiliary engine 138. CVT drive pulley 139 is mounted on output shaft 140 of primary engine 137 and is connected to CVT driven pulley 141 by drive belt 142. CVT driven pulley 141 is mounted on jackshaft 143 which is rotatably mounted on bearings 144. Jackshaft 143 is connected to input shaft 145 of speed change transmission 146 via endless chain 147 and sprockets 148. Power from speed change transmission 146 is conveyed to rear wheels 136 via propeller shaft 149 and differential 150.

Auxiliary engine 138 is coupled to fluid torque converter 151 via torque converter sprocket 152, endless chain 153 and sprag clutch sprocket 154 which is fixedly mounted on the outer race 155 of sprag clutch 156 whose inner race 157 is fixedly mounted on jackshaft 143. Sprag clutch 156 is a freewheeling clutch whose outer race 155 automatically engages (and drives) the inner race 157 whenever the rate of rotation of the outer race 155 exceeds that of inner race 157, and automatically disengages when the rate of rotation of outer race 155 is less than that of inner race 157.

To operate vehicle 131, primary engine 137 and auxiliary engine 138 are started and speeded up. When the rate of rotation of primary engine output shaft 140 exceeds the engagement speed of CVT drive pulley 139, drive pulley 139 engages and drives driven pulley 141 via drive belt 142 which turns jackshaft 143. Power from auxiliary engine 138 is conveyed to said jackshaft via torque converter 151, sprocket 152, endless chain 153, sprag clutch sprocket 154 and sprag clutch outer race 155 which causes sprag clutch 156 to engage and cause inner race 157 to turn jackshaft 143, thus combining the power of auxiliary engine 138 with that of primary engine 137 to turn said jackshaft.

Power from jackshaft 143 is then conveyed to speed change transmission 146 via endless chain 147 and sprockets 148, and the power is in turn transmitted via transmission 146, propeller shaft 149, and differential 150 to rear wheels 136 to drive the vehicle 131. After the vehicle 131 reaches cruising speed, the auxiliary engine may be throttled down to idle speed or stopped altogether to conserve fuel. When the speed of auxiliary engine 138 falls below that of primary engine 137, sprag clutch 156 automatically disengages so that neither auxiliary engine 138 or associated torque converter 151 can exert drag on jackshaft 143. The vehicle 131 will then continue to travel fuel-efficiently on power from primary engine 137 alone.

Fuel supply to primary engine 137 is regulated through primary engine gas pedal 158, and fuel supply to auxiliary engine 138 is regulated through auxiliary engine gas pedal 159 which is located alongside gas pedal 158 so that the operator may conveniently depress either pedal singly or depress both pedals at the same time with one foot. He may then easily elect to operate both engines for maximal power, or operate only said primary engine for maximal fuel economy. It should be noted that whenever primary engine 137 slows down below the engagement speed of CVT drive pulley 139, the associated CVT torque converter automatically disengages.

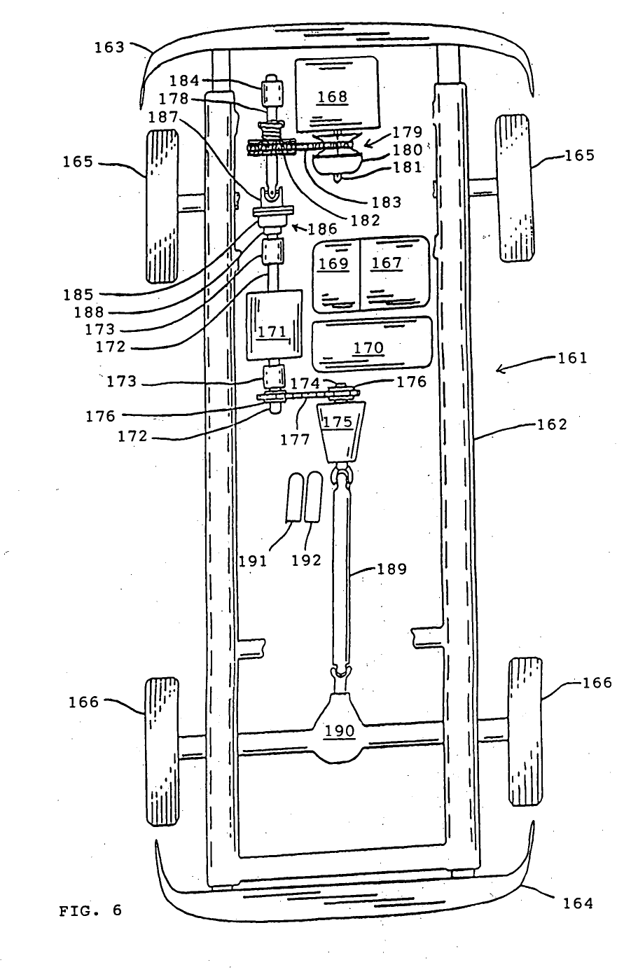

FIG. 6 shows a particularly fuel efficient embodiment amenable to easy construction. It comprises a vehicle 161 having a chassis 162, front bumper 163, rear bumper 164, front wheels 165, rear wheels 166, primary engine 167 and auxiliary engine 168. Primary engine 167 is directly coupled to generator 169 which charges battery 170 and supplies current to drive motor-generator 171. Battery 170 also supplies electric current to drive motor-generator 171, and receives current from motor generator 171 during regenerative braking. The axial shaft of motor-generator 171 serves as primary jackshaft 172 which is journaled to chassis 162 through bearings 173 and is coupled to the input shaft 174 of transmission 175 via sprockets 176 and endless chain 177.

Auxiliary engine 168 is coupled to auxiliary jackshaft 178 via CVT torque converter 179 whose drive pulley 180 is mounted on output shaft 181 of auxiliary engine 168, and whose driven pulley 182 is mounted on auxiliary jackshaft 178. Drive belt 183 connects drive pulley 180 to driven pulley 182. The front end of auxiliary jackshaft 178 is journaled to chassis 162 via auxiliary bearing 184 and its rear end is coupled to the outer race 185 of sprag clutch 186 via universal joint 187. Sprag clutch 186 is a freewheeling clutch which automatically engages when the speed of rotation of the outer, “driver” race 185 exceeds the rate of rotation of the inner (“driven”) race 188, and then automatically disengages when the speed of rotation of the outer race 185 falls below the speed of rotation of the inner race 188.

To operate vehicle 161, primary engine 167 is started up and run to power generator 169 which supplies electricity to battery 170 and motor-generator 171. Battery 170 also supplies stored current to motor-generator 171 which then transmits mechanical power to jackshaft 172. Similarly, auxiliary engine 168 is started and speeded up to a speed in excess of the “engagement speed” of drive pulley 180 of CVT torque converter 179, causing the drive pulley to transmit power to driven pulley 182 via drive belt 183, thereby transmitting mechanical power to auxiliary jackshaft 178, thence via universal joint 187 to sprag clutch outer race 185 which then drives inner race 188 which conveys additional power to jackshaft 172 upon which it is mounted. The combined power of motor-generator 171 and auxiliary engine 168 is then conveyed to speed change transmission 175 via endless chain 177 and sprockets 176, thence to propeller shaft 189 and differential 190 to drive wheels 166.

To control the operation of vehicle 161, a rheostat pedal 191 is employed alongside the gas pedal 192 in the operator's seating area so that he can control the flow of power from electric motor-generator 171 in accordance to the power needed for the proper operation of the vehicle. Gas pedal 192 controls the flow of fuel to auxiliary engine 168 so that the operator can control the flow of power from auxiliary engine 168 in accordance to the power needed for the proper operation of the vehicle, particularly for acceleration, climbing a grade, towing and carrying heavy loads. Primary engine 167 may be equipped with preset controls to permit automatic starting and running of said primary engine 167 to replenish the charge of battery 170 whenever said battery is discharged to a predetermined degree, and to automatically stop running when said battery is fully charged. Said automatic controls may be further designed to run said engine at optimal speeds to supply additional power to motor-generator 171 whenever the operator signals a need for more electricity than what battery 170 can deliver, such as by further depressing rheostat pedal 191. Thus, the need for yet another accelerator pedal to directly control fuel flow to primary engine 169 is eliminated. If the operator finds that he needs yet more power than motor-generator 171 (when powered by both battery 170 and generator 169 simultaneously) can deliver, he can then simply depress both rheostat pedal 191 and gas pedal 192 simultaneously, to avail of maximal supply of power from both motor-generator 171 and auxiliary engine 168.

When the vehicle 161 reaches cruising speed, auxiliary engine 168 may be deactivated so that the vehicle can travel economically on power from motor-generator 171 alone. Motor-generator 171 and its controls may be further designed so that it can generate electricity through regenerative braking to assist in recharging battery 170 to further enhance the fuel-efficiency of the vehicle.

Rheostat pedal 191 and gas pedal 192 are positioned alongside each other in such a manner that enables the operator to selectively operate either motor-generator 171 or auxiliary engine 168 by selectively depressing rheostat pedal 191 or gas pedal 192. To-operate both motor-generator 171 and auxiliary engine 168 at the same time he simply depresses both pedals simultaneously.

It may be seen that this particular embodiment employing a coaxial two section jackshaft, has the additional advantages of (1) enhancing fuel efficiency through regenerative braking, and (2) added versatility afforded by the use of a CVT torque converter 179 to connect the auxiliary engine 168 to auxiliary jackshaft section 178, resulting in continuously variable torque multiplication which may be used either to enhance acceleration performance or to permit reduction of the size and power of auxiliary motor 168, resulting in reduction of the weight and cost of the vehicle.

Other additional alternative embodiments of the invention may be made by using other combinations of clutches and torque converters to connect the primary and the auxiliary engines to the jackshaft, such as by using an electromagnetic power clutch or a centrifugal clutch to connect either engine to the jackshaft in combination with a CVT torque converter or a fluid torque converter for the other engine, or even the combination of an electric generator with associated battery and electric motor.

Although the preferred embodiments are described in great detail, it is to be understood that various changes and modifications may be made therein without departing from the scope of the invention as described in the appended claims.

Having thus described my invention, what is claimed is:

1) A motor vehicle having a chassis elongated upon a center axis between paired front and paired rear wheels, and a power train comprised of:
a) primary and auxiliary internal combustion engines located one in front of the other adjacent said front wheels, each engine having a power output shaft extending in parallel juxtaposition with said center axis and both having the same direction of rotary motion,
b) releasible coupling and power transfer means associated with each output shaft,
c) a speed change transmission positioned rearwardly of said engines and having an input shaft, and
d) a jackshaft laterally spaced from said engines in parallel relationship to said center axis, and rotatably secured by said chassis to selectively receive and accumulate power from said engine output shafts and convey said accumulated power to the input shaft of said speed change transmission, whereby
e) economy of operation is achieved by deactivating one engine when lesser power is needed for propulsion of the vehicle.

2) The vehicle of claim 1 wherein said releasable coupling and power transfer means comprises a movable sheave torque converter unit that produces continuously variable output rotational speeds.

3) The vehicle of claim 1 wherein said releasable coupling and power transfer means comprises a fluid torque converter.

4) The vehicle of claim 1 wherein said jackshaft is comprised of two sections in coaxial alignment, each section being interactive with a separate engine, said sections being releasibly coupled by speed activated clutch means.

5) The vehicle of claim 1 wherein said power train is further comprised of a storage battery and an electric motor which selectively adds power to said jackshaft.

6) The vehicle of claim 5 wherein said power train further comprises at least one engine-driven generator which produces an electrical output that energizes said motor and re-charges said battery.

7) The vehicle of claim 1 wherein said engines are gasoline operated.

8) The vehicle of claim 7 wherein the speed of operation of each engine is controlled by separate supply of gasoline.

9) The vehicle of claim 8 wherein said separate supply of gasoline is provided by way of separate accelerator pedals conventionally located near the vehicle operator.

10) The vehicle of claim 5 further equipped with regenerative braking which serves to re-charge said battery.

11) The vehicle of claim 1 wherein said primary engine is of lower horsepower than said auxiliary engine, and said auxiliary engine is available for activation only when the vehicle requires additional driving power.

12) The vehicle of claim 11 wherein the horsepower of said primary engine is ½ to ⅓ the horsepower of the auxiliary engine.

13) The vehicle of claim 1 wherein said jackshaft selectively receives power from said engines by way of an intervening free-wheeling clutch.

14) The vehicle of claim 13 wherein said clutch is a sprag clutch.

15) The vehicle of claim 5 wherein said electric motor has an output shaft which constitutes a section of a jackshaft comprised of two sections in coaxial alignment.
